(19) United States
(12) Patent Application Publication
(10) Pub. No.: US 2005/0139648 A1
(43) Pub. Date: Jun. 30, 2005

(54) Vibration pickup

(76) Inventor: Yung-Nien Chen, Douliu City (TW)

Correspondence Address: CHARLES E. BAXLEY, ESQ., 90 JOHN STREET, THIRD FLOOR, NEW YORK, NY, 10038, US

(21) Appl. No.: 11/022,355

(22) Filed: Dec. 22, 2004

(30) Foreign Application Priority Data
Dec. 25, 2003 (CN) 200320125352.7

(51) Int. Cl. G01C 22/00

(52) U.S. Cl. 235/105

(57) ABSTRACT

The present invention provides a vibration pickup, which is comprised of a main body, a torsion-bar spring located on the main body, a swing arm and a trigger head, wherein, a moving contact is built upon the bottom side of the swing arm orienting to the sway downward, a stationary contact is built upon the proper position coordinating to the moving contact on the main body so as to bring them to touch against exactly, when the swing arm is swung by extra vibration from the outside, the moving contact is moved down along with swing arm to strike on the stationary contact exactly to bring the switch to close-state instantly. Comparing with the prior art, the present invention has a simplified structure with higher induction sensitivity. Additionally, said main body is used for securing a base locating the swing arm, the torsion-bar spring and the stationary contact by fitting stop levers into location holes, within the swing arm holding with the trigger head, the torsion-bar spring and the stationary contact are sequentially combined on said base, via a pair of contactors and the main body to form a loop for further facilitating to manufacturing and examining. On the other hand, said shaft of the swing arm extends two curved gudgeons from the both end separately coordinating to the curved supporting holes so as to make the contact between them in point contact as fitting together for improving the induction sensitivity of the vibration pickup. And, even if the vibration pickup is tilted or offset, the point contact between the gudgeon and the supporting hole will keep the rolling friction between them as moving; the swing arm of the vibration pickup is still kept in high sensitivity.

### BACKGROUND OF THE INVENTION

1. Field of the Invention

The present invention relates to a vibration pickup, which can be used in pedometers, counters, inducers and so on.

2. Description of Prior Art

In accordance with the conventional technology, the structure of the most of the vibration pickup, as shown in FIG. 1, is comprised of a main body 1′, a torsion-bar spring 2′ located on the main body 1′, a swing arm 4′ and a trigger head 3′, wherein, when the swing arm 4′ is swung by extra vibration from the outside, the trigger head 3′ is also brought to shake to make the moving contact built upon the back side of the trigger head 3′ (not shown in drawings) touch against the stationary contact (metal contact) located on the main body 1′ to bring the switch to close-state instantly (as shown in FIG. 2), then under the restoring action of the torsion-bar spring 2′, the pair of moving and stationary contacts 5′ are skipped out to appearance off-state (resuming the original state as shown in FIG. 1), if it is used in a counter, it will make the counter accumulate one.

But after analyzing the structure of it carefully, some shortcomings are found easily as follows:
1. because the moving contact built upon the trigger head 3′ and the stationary contact located on the main body 1′ are separately built on the parallel surfaces oppositely, so in combination, it is difficult to take aim exactly, a little gap is easily brought up, therefore, as swaying, the moving contact will not touch against the stationary contact 5′ to affect the accuracy of goods;
2. because the amplitude of the swing arm 4′ is affected by position of the trigger head 3′ on it, meanwhile the position of the trigger head 3′ located on the swing arm 4′ is unadjusted, so for keeping accurate contacting between the moving and stationary contacts, the process of manufacturing is intractable to occur poor sensitivity and high rejection rate;

Referring to FIG. 3, it is showing the shaft 7′ structure of the swing arm 4,′ within said shaft 7′ has two cylindrical gudgeons 71′ extended out from the both ends for fitting into coordinated supporting holes 81′ of the housing 8′.

In this structure, the gudgeons 71′ contact the supporting holes 81′ in the contacting lines individually, so the motion between them is in sliding friction to create huge grip resistance, further to reduce the sensitivity of the swing arm 4′ of the vibration pickup.

Additionally, when the vibration pickup is tilted or offset, as shown in FIG. 4, the shoulders 72′ of the shaft 7′ may touch against the end surfaces of the housing 8′ to generate sliding friction between them, further to reduce the sensitivity of the swing arm 4′ of the vibration pickup.

### OBJECTS AND SUMMARY OF THE INVENTION

It is therefore the main object of the present invention to provide a vibration pickup with high accuracy of sensitive action.

It is an other object of the present invention to provide a vibration pickup that is easy to be manufactured and combined.

It is the last object of the present invention to provide a vibration pickup, in which the shaft of the swing arm has less sliding resistance as motion; meanwhile the vibration pickup has more sensitivity.

For archiving the objects, the technical solution provided by the present invention is to provide a vibration pickup, which is comprised of a main body, a torsion-bar spring located on the main body, a swing arm and a trigger head, wherein, a moving contact is built upon the bottom side of the swing arm orienting to the sway downward, a stationary contact is built upon the proper position coordinating to the moving contact on the main body so as to bring them to touch against exactly, when the swing arm is swung by extra vibration from the outside, the moving contact is moved down along with swing arm to strike on the stationary contact exactly to bring the switch to close-state instantly.

Said main body is used for securing a base locating the swing arm, the torsion-bar spring and the stationary contact by fitting stop levers into location holes, within the swing arm holding with the trigger head, the torsion-bar spring and the stationary contact are sequentially combined on said base, via a pair of contactors and the main body to form a loop. In combination, firstly the finished trigger head, swing arm, torsion-bar spring and stationary contact are sequentially mounted on the base, and examined carefully, then the combined base is fastened on the main body with stop levers to finish the whole goods easily.

Said trigger head is adjustably secured on the tip end of the swing arm extended out the base, meanwhile suspended out form the base for facilitating to adjusting the position of the trigger head along the long slot of the swing arm to improve the sensitivity of the induction.

Said stationary contact is built upon the location strap located on the main body.

Said swing arm has a through long slot built upon the suspended end for securing the trigger head with a screw crossing the long slot, by moving the secured position along the long slot, the trigger head is adjusted on the swing arm.

Said shaft of the swing arm extends two curved gudgeons from the both end separately coordinating to the curved supporting holes so as to make the contact between them in point contact as fitting together.

Said supporting hole of the housing is formed in hemispheroid, and said gudgeons of the shaft are in hemisphere.

Said supporting hole of the housing is formed in curved recess with a curved chamfer crossing the end surface of the housing smoothly.

Said supporting hole of the housing is formed in curved recess with a coned bevel firstly connecting to a curved chamfer, then crossing the end surface of the housing smoothly.

Said curved supporting hole of the housing has an under-port built on the closed end for containing some lubricating oil.

Due to applying said structure, it simplifies the structure, the cope and drag contact of the moving contact and the stationary contact replacing of the conventional parallel vertical contact further greatly improves the induction sensitivity. Additionally, the base is separated from the main body for pre-mounting the swing arm, the torsion-bar spring and the stationary contact so that the adjustment and examination is finished conveniently; therefore, the goods are manufactured and combined easily.

Additionally, due to designing the supporting hole of the housing of the swing arm into curved recess, meanwhile the gudgeon of the shaft of the swing arm is designed into curved surface, so as the gudgeon is fit into the supporting hole, the both curved surfaces contact into point contact, so as to generate rolling friction as they relatively move, the friction resistance is greatly reduced comparing with the conventional technology, meanwhile the induction sensitivity is efficiently improved. And even if the vibration pickup is tilted or offset, the point contact between the gudgeon and the supporting hole will keep the rolling friction between them as moving; the swing arm of the vibration pickup is still kept in high sensitivity.

### BRIEF DESCRIPTION OF THE DRAWINGS

FIG. 1 is top side view of the prior art.

FIG. 2 is a top solid view showing the action of the prior art.

FIG. 3 is a part sectional view showing the shaft structure of the swing arm of the prior art.

FIG. 4 is a part sectional view showing the shaft of the swing arm in tilted or offset position of the prior art.

FIG. 5 is a top side view of the present invention.

FIG. 6 is a top side view showing the combined base of the present invention.

FIG. 7 is a sectional view showing A-A cross-section of FIG. 6.

FIG. 8 is a sectional view showing B-B cross-section of FIG. 6.

FIG. 9 is a sectional view showing B-B cross-section in another embodiment of FIG. 6.

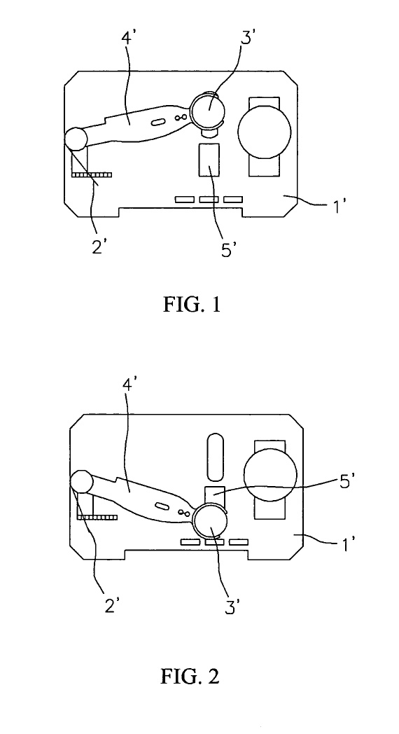

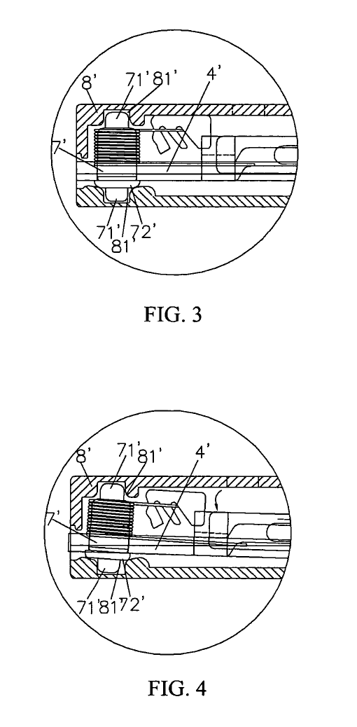

### DETAILED DESCRIPTION OF PREFERRED EMBODIMENTS

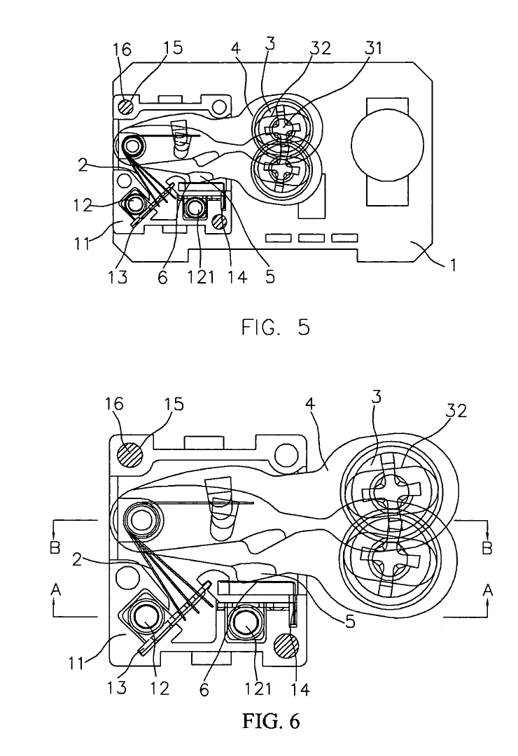

Referring to FIG. 5, a vibration pickup provided by present invention is comprised of a main body 1, a torsion-bar spring 2 located on the main body 1, a swing arm 4 and a trigger head 3, wherein said main body 1 and torsion-bar spring-2 and the swing arm 4 are as same as the prior art in relative positions, said swing arm 4 is hung on the main body 1 via a shaft, said torsion-bar spring 2 is put on the outside of said shaft, therein one end of the spring 2 is located on the swing arm 4, the another is located on an adjustable gauge plate 13 that is fastened on the main body 1, said adjustable gauge plate has a set of location slots, by locating one end of the torsion-bar spring 2 in different slot, the restoring force of the torsion-bar spring 2 can be adjusted in desired, as shown in FIG. 6, the broken line shows the part of the torsion-bar spring 2.

The feathers of the present invention is that a moving contact 5 is built upon the bottom side of the swing arm 4 orienting to the sway downward, a stationary contact 6 is built upon the proper position convexly coordinating to the moving contact 5 on the main body 1, as shown in FIG. 5 and FIG. 6, said stationary contact 6 is located on a location strap 14 fastened on the main body 1.

When the swing arm 4 is swung by extra vibration from the outside, the moving contact 5 is moved down along with the swing arm 4 to strike on the stationary contact 6 exactly to bring the switch to close-state instantly.

For facilitating to manufacturing, combination easily, the present invention uses the main body 1 as a seat for holding in a base 11, which is used for mounting said swing arm 4, said torsion-bar spring 2 and said stationary contact 6, by fitting stop levers 16 into location holes 15; therein, the swing arm 4 holding with the trigger head 3, the torsion-bar spring 2 and the stationary contact 6 are sequentially combined on said base 11, cooperating to the moving contact 5 and the stationary contact 6 via a pair of contactors 12 and 12′ and the main body 1 to form a loop, which is stated from one contactor 12 passing through the adjustable gauge plate 13, the torsion-bar spring 2, the swing arm 4, the moving contact 5, the stationary contact 6, the location strap 14, the another contactor 12′ to the main body 1 to construct a loop.

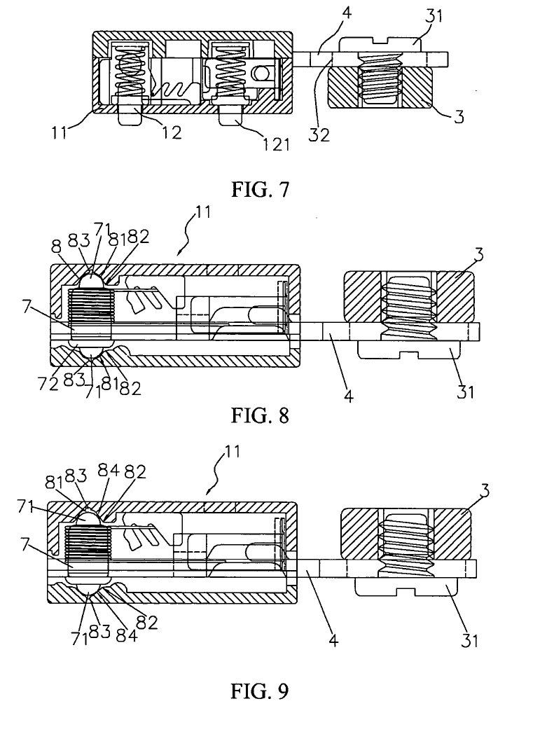

Referring to FIG. 7, said trigger head 3 is adjustably secured on the tip end of the swing arm 4 with a screw 31, as shown in FIG. 5 and FIG. 6, for this said swing arm 4 has a through long-slot 32 with the screw 31 crossing the slot 32 to adjust the position of the trigger head 3 by sliding them together along the slot 32 until to get the desired position and secure it on there; because the end securing the trigger head 3 of the swing arm 4 is extended out said base 11 so that the adjustment is more convenient with the screw 31, the induction is more accurate.

In combination, firstly the finished trigger head 3, swing arm 4, torsion-bar spring 2 and stationary contact 6 are sequentially mounted on the base 11, and examined carefully, then the combined base 11 is fastened on the main body 1 with stop levers 16 to finish the whole goods easily.

Referring to FIG. 8, it is showing the structure of the shaft 7 of said swing arm 4, therein the supporting hole 81 of the housing 8 is designed into curved recess, in this embodiment said supporting hole 81 appears into a hemispheroid coordinating to the curved surface of the gudgeon 71 of the shaft 7, in this embodiment the gudgeon 71 of the shaft 7 is to appear to hemisphere for fitting into said supporting hole 81 so that the contact between them is in point contact. So, the relative motion between them is in rolling moving, the friction force is much less than the prior art's sliding friction, the induction sensitivity is much improved; additionally, even if the vibration pickup is tilted or offset, the point contact between the gudgeon 71 and the supporting hole 81 will keep the rolling friction between them as moving; the swing arm 4 of the vibration pickup is still kept in high sensitivity.

In this embodiment, the supporting hole 81 of the housing 8 is formed in curved recess with a curved chamfer 82 crossing the end surface of the housing 8 smoothly for facilitating to avoid the tilted or offset vibration pickup occurring friction between the shoulder 72 of the shaft 7 and the end surface of the housing 8, to keep the swing arm 4 in high induction sensitivity.

Referring to FIG. 9, it is showing the structure of the shaft 7 of the swing arm 4 in another embodiment. In this embodiment, said supporting hole 81 of the housing 8 is formed in curved recess with a coned bevel 84 firstly connecting to a curved chamfer 82, then crossing the end surface of the housing 8 smoothly for facilitating to avoid the tilted or offset vibration pickup occurring friction between the shoulder 72 of the shaft 7 and the end surface of the housing 8, to keep the swing arm 4 in high induction sensitivity.

Referring to FIG. 8 and FIG. 9, for further decreasing the friction force, said curved supporting hole 81 of the housing 8 has an under-port 83 built on the closed end for containing some lubricating oil, thereby reducing the friction between the gudgeon 71 and the supporting hole 81 to minimal so that the swing arm 4 is kept in higher induction sensitivity.

1. a vibration pickup comprised of a main body, a torsion-bar spring located on the main body, a swing arm and a trigger head, wherein, a moving contact is built upon the bottom side of the swing arm orienting to the sway downward, a stationary contact is built upon the proper position coordinating to the moving contact on the main body so as to bring them to touch against exactly, when the swing arm is swung by extra vibration from the outside, the moving contact is moved down along with swing arm to strike on the stationary contact exactly to bring the switch to close-state instantly;

2. a vibration pickup as claimed in claim 1, wherein said main body is used for securing a base locating the swing arm, the torsion-bar spring and the stationary contact by fitting stop levers into location holes, within the swing arm holding with the trigger head, the torsion-bar spring and the stationary contact are sequentially combined on said base, via a pair of contactors and the main body to form a loop;

3. a vibration pickup as claimed in claim 1, wherein said trigger head is adjustably secured on the tip end of the swing arm extended out the base, meanwhile suspended out form the base for facilitating to adjusting the position of the trigger head in left and right;

4. a vibration pickup as claimed in claim 1, wherein said stationary contact is built upon the location strap located on the main body;

5. a vibration pickup as claimed in claim 1, wherein said swing arm has a through long slot built upon the suspended end for securing the trigger head with a screw crossing the long slot, by moving the secured position along the long slot, the trigger head is adjusted on the swing arm;

6. a vibration pickup as claimed in claim 1, wherein the structure of the shaft of the swing arm is that the supporting hole of the housing is designed into curved recess, coordinating to the curved surface of the gudgeon of the shaft for fitting into said supporting hole so that the contact between them is in point contact;

7. a vibration pickup as claimed in claim 6, wherein said supporting hole appears into a hemispheroid, and the gudgeon of the shaft is to appear to hemisphere;

8. a vibration pickup as claimed in claim 6, wherein said supporting hole of the housing is formed in curved recess with a curved chamfer crossing the end surface of the housing smoothly;

9. a vibration pickup as claimed in claim 6, wherein said supporting hole of the housing is formed in curved recess with a coned bevel firstly connecting to a curved chamfer, then crossing the end surface of the housing smoothly;

10. a vibration pickup as claimed in anyone of claim 6, wherein said curved supporting hole of the housing has an under-port built on the closed end for containing some lubricating oil.

11. a vibration pickup as claimed in anyone of claim 7, wherein said curved supporting hole of the housing has an under-port built on the closed end for containing some lubricating oil.

12. a vibration pickup as claimed in anyone of claim 8, wherein said curved supporting hole of the housing has an under-port built on the closed end for containing some lubricating oil.

13. a vibration pickup as claimed in anyone of claim 9, wherein said curved supporting hole of the housing has an under-port built on the closed end for containing some lubricating oil.
